(19) United States
(12) Patent Application Publication
(10) Pub. No.: US 2025/0309747 A1
(43) Pub. Date: Oct. 2, 2025

(54) SWITCHING CONVERTER WITH ADAPTIVE BUS REGULATION

(71) Applicant: Chengdu Monolithic Power Systems Co., Ltd., Chengdu (CN)

(72) Inventors: Jie Shen, Hangzhou (CN); Hui Li, Hangzhou (CN); Xia Zhou, Hangzhou (CN)

(21) Appl. No.: 19/090,285

(22) Filed: Mar. 25, 2025

(30) Foreign Application Priority Data
Mar. 26, 2024 (CN) 202410346838.X

(51) Int. Cl. H02M 1/00; H02M 1/42; H02M 3/335

(52) U.S. Cl. CPC H02M 1/0019; H02M 1/0012; H02M 1/4225; H02M 3/33576

(57) ABSTRACT

A control circuit for a switching converter with a front stage circuit converting an input line voltage into a bus voltage and a rear stage circuit converting the bus voltage into an output voltage to power a load. The control circuit includes a rear stage control circuit providing a rear switch control signal to control the rear stage circuit and a front stage control circuit providing a front switch control signal to control the front stage circuit. The rear stage control circuit has a first pin and changes a voltage at the first pin based on an input line voltage state and a load state. The front stage control circuit has a second pin coupled to the first pin of the rear stage control circuit and regulates the bus voltage based on the voltage at the second pin.

### CROSS-REFERENCE TO RELATED APPLICATIONS

This application claims the benefit of CN application 202410346838.X, filed on Mar. 26, 2024, and incorporated herein by reference.

### TECHNICAL FIELD OF THE INVENTION

The present invention generally relates to electronic circuits, and more particularly but not exclusively, to switching converters.

### BACKGROUND OF THE INVENTION

Many switching converters use two-stage or even multi-stage voltage converting circuits to provide required power to loads. Take a switching converter with a front stage circuit and a rear stage circuit for example, there usually are a front stage control circuit for controlling the front stage circuit and a rear stage control circuit for controlling the rear stage circuit. For such switching converter with two-stage voltage converting circuits, it is critical to realize communication between the front stage control circuit and the rear stage control circuit so that the two-stage voltage converting circuits can cooperate well to provide the required power.

Furthermore, many loads, such as printers and scanners, have variable power demands, it depends on the specific functions performed by the loads. Many functions require medium or low power and a switching converter with normal operation can satisfy such low to medium power demands. Some functions, such as printer's paper scrolling function which requires the use of a motor, have peak power demand exceeding the power range that the switching converter with normal operation can provide.

Therefore, it is desired to provide a switching converter which can realize communication between the front stage control circuit and the rear stage control circuit to achieve good cooperation between the two-stage voltage converting circuits and can satisfy the low, medium and peak power demands of loads.

### SUMMARY OF THE INVENTION

An embodiment of the present invention discloses a control circuit for a switching converter with a front stage circuit converting an input line voltage into a bus voltage and a rear stage circuit converting the bus voltage into an output voltage to power a load. The control circuit includes a rear stage control circuit and a front stage control circuit. The rear stage control circuit is configured to provide a rear switch control signal to control the power operation of the rear stage circuit. The rear stage control circuit has a first pin and is configured to change a voltage at the first pin based on an input line voltage state and a load state. The front stage control circuit is configured to provide a front switch control signal to control the power operation of the front stage circuit. The front stage control circuit has a second pin coupled to the first pin of the rear stage control circuit and is configured to regulate the bus voltage based on a voltage at the second pin.

An embodiment of the present invention discloses a control circuit for a switching converter converting an input line voltage into a bus voltage. The control circuit includes a first pin, a second pin and a switch control circuit. The first pin is configured to receive information about a state of the input line voltage state and a state of a load. The second pin is configured to provide a switch control signal to control the power operation of the switching converter. The switch control circuit is coupled to the first pin and configured to generate the switch control signal based on a voltage at the first pin. The control circuit is configured to regulate the bus voltage to different values based on different state of the voltage at the first pin.

An embodiment of the present invention discloses a control circuit for a switching converter converting a bus voltage into an output voltage. The control circuit includes four pins, a load detecting circuit, a line voltage detecting circuit and a front state control circuit. A first pin is configured to receive a load signal indicative of a load. A second pin is configured to receive an input sampling signal indicative of an input line voltage. A fourth pin is configured to provide a switch control signal to control the power operation of the switching converter. The load detecting circuit is configured to detecting a state of the load based on the load signal. The line voltage detecting circuit is configured to detecting a state of the input line voltage based on the input sampling signal. The front state control circuit is configured to change a voltage at a third pin based on the load state and the input line voltage state.

### BRIEF DESCRIPTION OF DRAWINGS

The present invention can be further understood with reference to the following detailed description and the appended drawings, wherein like elements are provided with like reference numerals.

FIG. 1 illustrates a block diagram of a switching converter 100 in accordance with an embodiment of the present invention.

FIG. 2 illustrates a circuit schematic of a switching converter 100A in accordance with another embodiment of the present invention.

FIG. 3 illustrates a waveform of the bus voltage Vbus of the switching converter 100A in accordance with an embodiment of the present invention.

FIG. 4 illustrates waveforms of the voltage Vfb at the front feedback pin FB and the bus voltage Vbus of the switching converter 100A in accordance with an embodiment of the present invention.

FIG. 5 illustrates waveforms of the voltage Vfb at the front feedback pin FB and the bus voltage Vbus of the switching converter 100A in accordance with another embodiment of the present invention.

FIG. 6 illustrates a circuit schematic of a switching converter 200A in accordance with an embodiment of the present invention.

FIG. 7 illustrates a circuit schematic of a rear stage control circuit 22B used in the switching converter 200A in accordance with another embodiment of the present invention.

FIG. 8 illustrates a circuit schematic of a switching converter 200B in accordance with another embodiment of the present invention.

FIG. 9 illustrates a circuit schematic of a front stage control circuit 23B used in the switching converter 200B in accordance with another embodiment of the present invention.

FIG. 10 illustrates a working flowchart of a control method 1000 used in a switching converter in accordance with an embodiment of the present invention.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

Reference to “one embodiment”, “an embodiment”, “an example” or “examples” means: certain features, structures, or characteristics are contained in at least one embodiment of the present invention. These “one embodiment”, “an embodiment”, “an example” and “examples” are not necessarily directed to the same embodiment or example. Furthermore, the features, structures, or characteristics may be combined in one or more embodiments or examples. In addition, it should be noted that the drawings are provided for illustration and are not necessarily to scale. And when an element is described as “connected” or “coupled” to another element, it can be directly connected or coupled to the other element, or there could exist one or more intermediate elements. In contrast, when an element is referred to as “directly connected” or “directly coupled” to another element, there is no intermediate element.

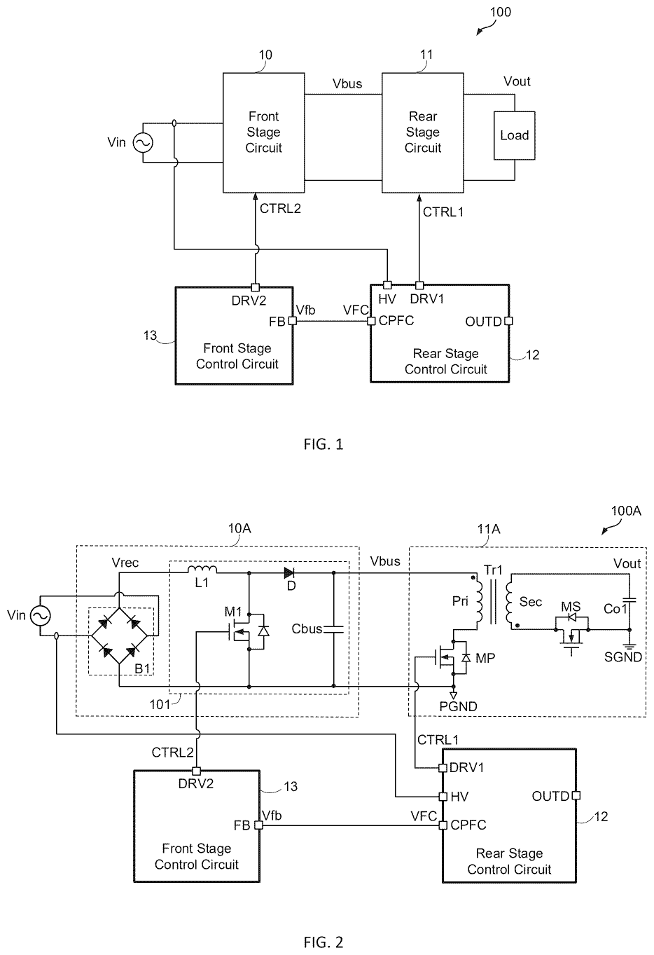

FIG. 1 illustrates a block diagram of a switching converter 100 in accordance with an embodiment of the present invention. As shown in FIG. 1, the switching converter 100 includes a front stage circuit 10, a rear stage circuit 11, a rear stage control circuit 12 and a front stage control circuit 13. The front stage circuit 10 receives an input line voltage Vin and converts the input line voltage Vin into a bus voltage Vbus. The rear stage circuit 11 is coupled to the front stage circuit 10 to receive the bus voltage Vbus and converts the bus voltage Vbus into an output voltage Vout to power a load.

The rear stage control circuit 12 generates a rear switch control signal CTRL1 to control the power operation of the rear stage circuit 11. In the example shown in FIG. 1, the rear stage control circuit 12 has a plurality of pins, including an output detecting pin OUTD, an input detecting pin HV, a rear driving pin DRV1 and a front control pin CPFC. The output detecting pin OUTD receives a load signal indicative of the load. The input detecting pin HV receives an input sampling signal indicative of the input line voltage Vin. The rear driving pin DRV1 provides the rear switch control signal CTRL1 to the rear stage circuit 11. The front control pin CPFC is coupled to the front stage control circuit 13. The rear stage control circuit 12 detects the state of the input line voltage Vin and the state of the load and changes a voltage VFC at the front control pin CPFC based on the detection results. That means, the voltage VFC at the front control pin CPFC contains the information about the state of the input line voltage Vin and the state of the load. In one embodiment, the state of the input line voltage Vin includes a high line state and a low line state, and the state of the load includes a light load state, a heavy load state and a peak power state.

In one embodiment, the output detecting pin OUTD is coupled to output terminals of the rear stage circuit 11 to receive the load signal indicative of the load. In another embodiment, the output detecting pin OUTD is coupled to a PD (power delivery) controller (not shown). The PD controller generates the load signal indicative of the load and applies the load signal on the output detecting pin OUTD. The rear stage control circuit 12 detects the state of the load based on the load signal on the output detecting pin OUTD.

The front stage control circuit 13 generates a front switch control signal CTRL2 to control the power operation of the front stage circuit 10. In the example shown in FIG. 1, the front stage control circuit 13 has a plurality of pins, including a front feedback pin FB and a front driving pin DRV2. The front feedback pin FB is coupled to the rear stage control circuit 12. The front driving pin DRV2 provides the front switch control signal CTRL2 to the front stage circuit 10.

As shown in FIG. 1, the front control pin CPFC of the rear stage control circuit 12 and the front feedback pin FB of the front stage control circuit 13 are coupled together. The rear stage control circuit 12 changes the voltage VFC at the front control pin CPFC based on the state of the input line voltage Vin and the state of the load. The voltage Vfb at the front feedback pin FB changes accordingly, thus the state of the input line voltage Vin and the state of the load can be transmitted to the front stage control circuit 13 from the rear stage control circuit 12. The front stage control circuit 13 recognizes the state of the input line voltage Vin and the state of the load by detecting the voltage Vfb at the front feedback pin FB and regulates the bus voltage Vbus based on the state of the input line voltage Vin and the state of the load.

In one embodiment, in response to different states of the input line voltage Vin and different states of the load, the voltage VFC at the front control pin CPFC has different states. For example, the voltage VFC may have different amplitudes. Due to the influence of the voltage VFC, the voltage Vfb at the front feedback pin FB also has different states. The front stage control circuit 13 can recognize the different states of the input line voltage Vin and the different states of the load by detecting the state of the voltage Vfb. This will be described in detail in following embodiments.

Those skilled in the art can understand that the state of the load and the state of the input line voltage Vin can be defined according to practical applications. For example, the state of the load can be defined based on an output power of the switching converter 100. A plurality of power thresholds can be set and then determine the state of the load by comparing the output power with the plurality of power thresholds. In one embodiment, when the output power is lower than a low power threshold, define the load as the light load state; when the output power is higher than the low power threshold and is lower than a high power threshold, define the load as the heavy load state; when the output power is higher than the high power threshold, define the load as the peak power state. Those skilled in the art can understand that the state of the load can also be defined based on an output voltage, an output current, or other electrical parameters.

Similarly, the state of the input line voltage Vin can be defined based on the input line voltage Vin. A single voltage threshold or a plurality of voltage thresholds can be set and then determine the state of the input line voltage Vin by comparing the input line voltage Vin with the single voltage threshold or the plurality of voltage thresholds. In one embodiment, when the peak value of the input line voltage Vin is higher than a high voltage threshold, define the input line voltage Vin as the high line state; when the peak value of the input line voltage Vin is lower than a low voltage threshold, define the input line voltage Vin as the low line state.

FIG. 2 illustrates a circuit schematic of a switching converter 100A in accordance with another embodiment of the present invention. As shown in FIG. 2, the front stage circuit 10A includes a boost PFC (power factor correction) circuit. The boost PFC circuit includes a rectifier B1 and a boost circuit 101. The rectifier B1 receives the input line voltage Vin and provide a rectified voltage Vrec based on the input line voltage Vin. The boost circuit 101 includes an inductor L1, a power switch M1, a diode D and a bus capacitor Cbus. A first terminal of the inductor L1 is coupled to the rectifier B1. The power switch M1 is coupled between a second terminal of the inductor L1 and a reference ground PGND. The diode D is coupled between the second terminal of the inductor L1 and the bus capacitor Cbus. Those skilled in the art can understand that the diode D can also be replaced by a controllable switch.

The front stage control circuit 13 generates the front switch control signal CTRL2 to control the turning on and the turning off of the power switch M1, thereby controlling the front stage circuit 10A to convert the input line voltage Vin into the bus voltage Vbus.

In the example shown in FIG. 2, the rear stage circuit 11A is shown as a flyback circuit, including a transformer Tr1, a primary switch MP, a secondary switch MS and an output capacitor Co1. The transformer Tr has a primary winding Pri and a secondary winding Sec, where both the primary winding Pri and the secondary winding Sec have a first terminal and a second terminal. The first terminal of the primary winding Pri is coupled to receive the bus voltage Vbus. The primary switch MP is coupled between the second terminal of the primary winding Pri and the reference ground PGND. The first terminal of the secondary winding Sec is coupled to provide the output voltage Vout. The secondary switch MS is coupled between the second terminal of the secondary winding Sec and a reference ground SGND. The output capacitor Co1 is coupled between the first terminal of the secondary winding Sec and the reference ground SGND. Those skilled in the art can understand that the secondary switch MS can also be coupled between the first terminal of the secondary winding Sec and the output capacitor Co1.

The rear stage control circuit 12 generates the rear switch control signal CTRL1 to control the turning on and the turning off of the primary switch MP, thereby controlling the rear stage circuit 12A to convert the bus voltage Vbus into the output voltage Vout. Those skilled in the art can understand that, in other embodiments, the rear stage control circuit 12 can also generate a switch control signal to control the turning on and the turning off of the secondary switch MS.

Those skilled in the art can understand that the boost PFC circuit and the flyback circuit shown in FIG. 2 is used for illustrative purpose, not for limiting the invention. In other embodiments, the front stage circuit 10 and the rear stage circuit 11 can also include other suitable topologies. For example, the front stage circuit 10 can include a totem pole PFC circuit and the rear stage circuit 11 can include an active clamp flyback circuit, an asymmetric flyback circuit and so on.

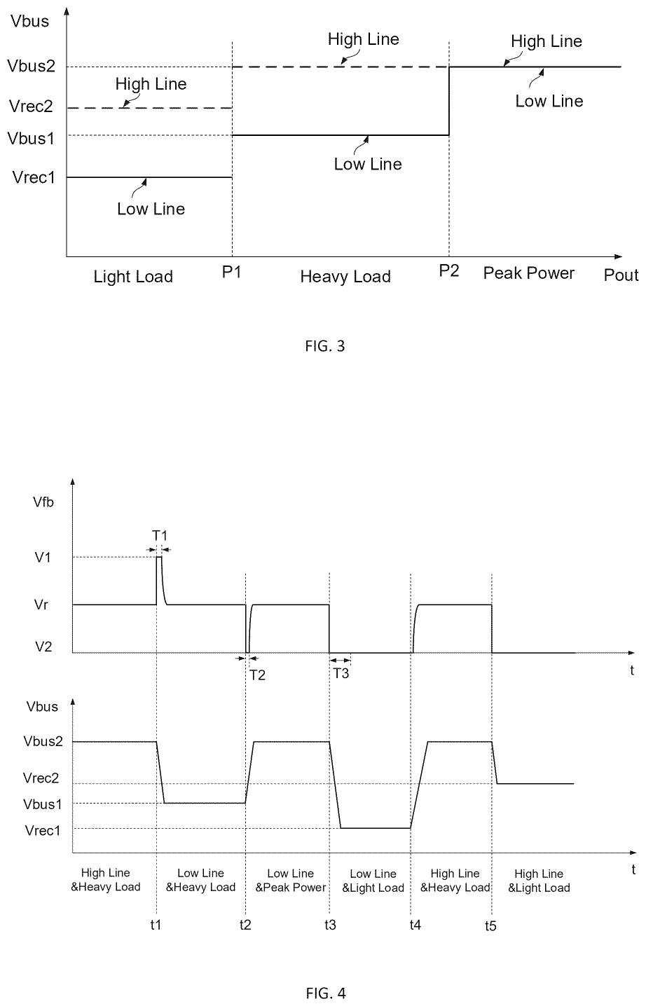

FIG. 3 illustrates a waveform of the bus voltage Vbus of the switching converter 100A in accordance with an embodiment of the present invention. In the example shown in FIG. 3, the vertical axis represents the bus voltage Vbus and the horizontal axis represents the output power Pout indicative of the load. When the output power Pout is lower than a low power threshold P1, it indicates that the load is in the light load state; when the output power Pout is higher than the low power threshold P1 and is lower than a high power threshold P2, it indicates that the load is in the heavy load state, where the low power threshold P1 is lower than the high power threshold P2; when the output power Pout is higher than the high power threshold P2, it indicates that the load is in the peak power state.

As shown in FIG. 3, when the load is in the light load state, regardless of whether the input line voltage Vin is in the high line state or the low line state, the front stage circuit 10A stops power operation. At this time, the bus voltage Vbus is equal to the rectified voltage Vrec, where the rectified voltage Vrec in the low line state is equal to a first rectified voltage vrec1 and the rectified voltage Vrec in the high line state is equal to a second rectified voltage vrec2, where the first rectified voltage Vrec1 is lower than the second rectified voltage Vrec2. In one embodiment, the front stage circuit 10A stops power operation means that the power switch M1 stops switching and the bus voltage Vbus is equal to the rectified voltage Vrec.

When the load is in the heavy load state, the bus voltage Vbus is regulated to different values according to the state of the input line voltage Vin. When the input line voltage Vin is in the low line state, the bus voltage Vbus is regulated to a first bus voltage Vbus1; when the input line voltage Vin is in the high line state, the bus voltage Vbus is regulated to a second bus voltage Vbus2, where the first bus voltage Vbus1 is lower than the second bus voltage Vbus2.

When the load is in the peak power state, regardless of whether the input line voltage Vin is in the high line state or the low line state, the bus voltage Vbus is regulated to the second bus voltage Vbus2.

According to the embodiments shown in FIGS. 1˜3, the bus voltage Vbus is regulated adaptively by comprehensively considering the state of the load and the state of the input line voltage Vin. The state information transmission is realized through the communication between the front control pin CPFC and the front feedback pin FB. This does not require additional elements and can reduce the cost of the switching converter. Besides, when the load is in the peak power state, regardless of whether the input line voltage Vin is in the high line state or the low line state, the bus voltage Vbus is regulated to the higher second bus voltage Vbus2. This can meet the peak power demand of the load better. When the load is in the heavy load state while the input line voltage Vin is in the low line state, the bus voltage Vbus is regulated to the lower first bus voltage Vbus1. This can reduce the power loss and improve the efficiency of the switching converter.

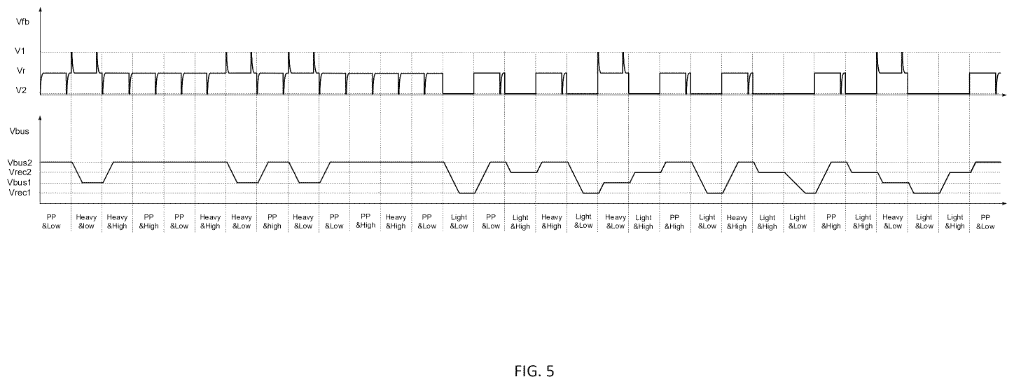

FIG. 4 illustrates waveforms of the voltage Vfb at the front feedback pin FB and the bus voltage Vbus of the switching converter 100A in accordance with an embodiment of the present invention.

Before the time t1, the input line voltage Vin is in the high line state and the load is in the heavy load state, the switching converter 100A operates in a steady state, the bus voltage Vbus is regulated to the second bus voltage Vbus2 and the voltage Vfb at the front feedback pin FB is equal to a reference voltage Vr. Those skilled in the art can understand that, when the switching converter 100A operates in the steady state, the bus voltage Vbus is regulated to a desired value by the control loop. At this time, the voltage Vfb at the front feedback pin FB is also regulated to a reference voltage value. In one embodiment, the reference voltage value is equal to the reference voltage of an error amplifying circuit in the control loop.

During the time period t1˜t2, the input line voltage Vin is in the low line state and the load is in the heavy load state. In response to the low line state and heavy load state, the voltage Vfb at the front feedback pin FB has a first state (e.g., the voltage Vfb is pulled up to a first voltage V1 and maintains the first voltage V1 for a first duration threshold T1). In response to the first state of the voltage Vfb, the bus voltage Vbus is regulated to the first bus voltage Vbus1.

During the time period t2˜t3, the input line voltage Vin is in the low line state and the load is in the peak power state. In response to the low line state and the peak power state, the voltage Vfb at the front feedback pin FB has a second state (e.g., the voltage Vfb is pulled down to a second voltage V2 and maintains the second voltage V2 for a second duration threshold T2). In response to the second state of the voltage Vfb, the bus voltage Vbus is regulated to the second bus voltage Vbus2.

During the time period t3˜t4, the input line voltage Vin is in the low line state and the load is in the light load state. In response to the low line state and the light load state, the voltage Vfb at the front feedback pin FB has a third state (e.g., the voltage Vfb is pulled down to the second voltage V2 and maintains the second voltage V2 for a duration exceeding a third duration threshold T3, where the third duration threshold T3 is longer than the second duration threshold T2). In response to the third state of the voltage Vfb, the front stage circuit 10 stops power operation and the bus voltage Vbus is equal to the first rectified voltage Vrec1.

During the time period t4˜t5, the input line voltage Vin is in the high line state and the load is in the heavy load state. In response to the high line state and the heavy load state, the voltage Vfb at the front feedback pin FB has the second state. In response to the second state of the voltage Vfb, the bus voltage Vbus is regulated to the second bus voltage Vbus2.

After time t5, the input line voltage Vin is in the high line state and the load is in the light load state. In response to the high line state and the light load state, the voltage Vfb at the front feedback pin FB has the third state. In response to the third state of the voltage Vfb, the front stage circuit 10 stops power operation and the bus voltage Vbus is equal to the second rectified voltage Vrec2.

In one embodiment, the first duration threshold T1 and the second duration threshold T2 may be 10 μs and the third duration threshold T3 is longer than 10 μs. In other embodiments, the first duration threshold T1 and/or the second duration threshold T2 can be other suitable durations shorter than 50 μs. In one embodiment, the reference voltage Vr can be about 2.5V, the first voltage V1 can be a value within the range of 3.5V˜5V and the second voltage V2 can be a value within the range of 0˜0.4V. In other embodiments, the first voltage V1 and the second voltage V2 can also be other suitable voltage values.

The example shown in FIG. 4 only illustrates several situations of the load state and the input line voltage state, there are also other combination situations of the load state and the input line voltage state which are not listed one by one in FIG. 4. FIG. 5 illustrates waveforms of the voltage Vfb at the front feedback pin FB and the bus voltage Vbus of the switching converter 100A in accordance with another embodiment of the present invention. The waveforms under different situations of the load state and the input line voltage state are shown, where PP, heavy and light in FIG. 5 represent the peak power state, the heavy load state and the light load state respectively, and low and high in FIG. 5 represent the low line state and the high line state respectively. When the load is in the heavy load state and the input line voltage Vin is in the low line state, the voltage Vfb at the front feedback pin FB has the first state; when the load is in the heavy load state and the input line voltage Vin is in the high line state or when the load is in the peak power state, the voltage Vfb has the second state; when the load is in the light load state, the voltage Vfb has the third state. In response to the first state of the voltage Vfb, the bus voltage Vbus is regulated to the first bus voltage Vbus1; in response to the second state of the voltage Vfb, the bus voltage Vbus is regulated to the second bus voltage Vbus2; in response to the third state of the voltage Vfb, the front stage circuit 10 stops power operation and the bus voltage Vbus is equal to the first rectified voltage Vrec1 in the low line state and equal to the second rectified voltage Vrec2 in the high line state.

The different situations of the load state and the input line voltage state are distinguished by the different amplitudes and maintaining durations of the voltage Vfb in the above embodiments. However, those skilled in the art can understand that in other embodiments, the voltage Vfb may also be a signal with different frequencies, different amplitudes, different pulse widths or combination thereof, as long as the different situations of the load state and the input line voltage state can be distinguished according to the voltage Vfb. For example, in one embodiment, when the voltage Vfb is pulled up to the first voltage V1 for three times, it is considered that the voltage Vfb has the first state. When the voltage Vfb is pulled down to the second voltage V2 and then increases from the second voltage V2 to the reference voltage Vr, it is considered that the voltage Vfb has the second state.

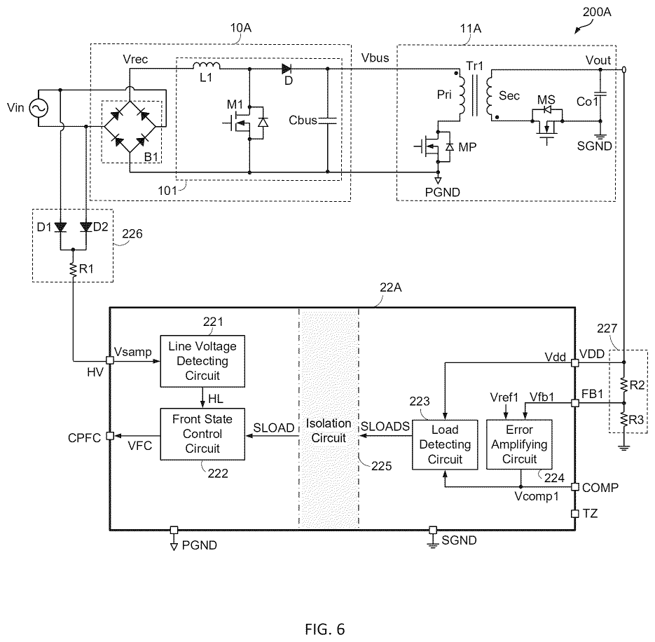

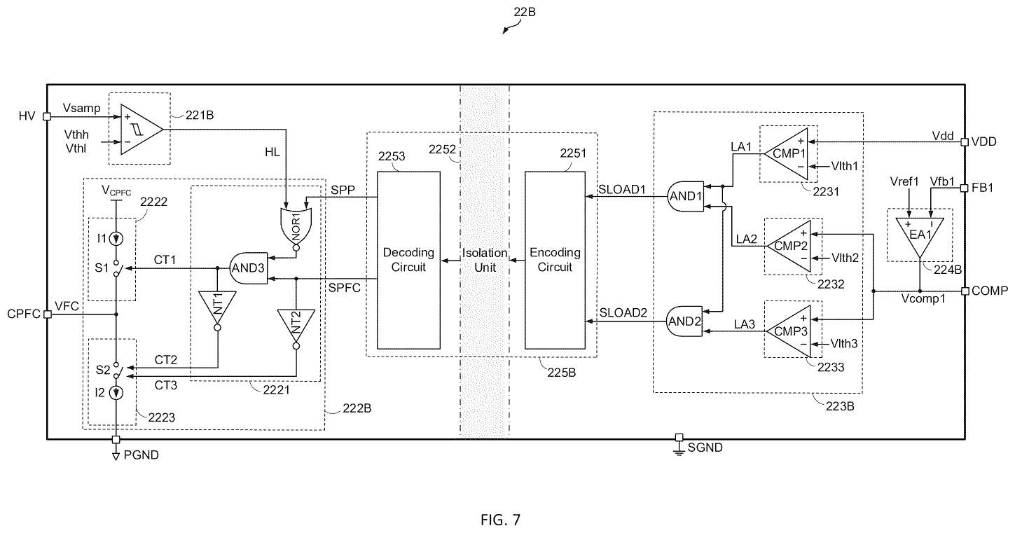

FIG. 6 illustrates a circuit schematic of a switching converter 200A in accordance with an embodiment of the present invention. As shown in FIG. 6, the switching converter 200A includes a front stage circuit 10A, a rear stage circuit 11A and a rear stage control circuit 22A for controlling the power operation of the rear stage circuit 11A.

In the example shown in FIG. 6, the rear stage control circuit 22A includes a line voltage detecting circuit 221, a front state control circuit 222, an input detecting pin HV and a front control pin CPFC.

The line voltage detecting circuit 221 is coupled to the input detecting pin HV to receive an input sampling signal Vsamp indicative of the input line voltage Vin and generates a line voltage detecting signal HL indicative of the state of the input line voltage Vin. In one embodiment, when the line voltage detecting signal HL is valid (e.g., high level), it indicates that the input line voltage Vin is in the high line state. In one embodiment, the switching converter 200A further includes an input sampling circuit 226 coupled to the input line voltage Vin. The input sampling circuit 226 includes diodes D1, D2 and resistor R1 for generating the input sampling signal Vsamp.

The front state control circuit 222 receives the line voltage detecting signal HL and a load detecting signal SLOAD indicative of the state of the load and changes the voltage VFC at the front control pin CPFC based on the line voltage detecting signal HL and the load detecting signal SLOAD. In one embodiment, when the load is in the heavy load state and the input line voltage Vin is in the low line state, the voltage VFC has a first state; when the load is in the heavy load state and the input line voltage Vin is in the high line state or when the load is in the peak power state, the voltage VFC has a second state; when the load is in the light load state, the voltage VFC has a third state.

In a further embodiment, when the voltage VFC is pulled up to the first voltage V1 and maintains the first voltage V1 for the first duration threshold T1, it is considered that the voltage VFC has the first state; when the voltage VFC is pulled down to the second voltage V2 and maintains the second voltage V2 for the second duration threshold T2, it is considered that the voltage VFC has the second state; when the voltage VFC is pulled down to the second voltage V2 and maintains the second voltage V2 for the duration exceeding the third duration threshold T3, it is considered that the voltage VFC has the third state. Those skilled in the art can understand that the above different states of the voltage VFC can be represented in other ways to distinguish different situations of the load state and input line voltage state. For example, in one embodiment, when the voltage VFC is pulled up to the first voltage V1 for three times, it is considered that the voltage VFC has the first state; when the voltage VFC is pulled down to the second voltage V2 and then increases, it is considered that the voltage VFC has the second state.

In the example shown in FIG. 6, the rear stage control circuit 22A also includes a load detecting circuit 223. The load detecting circuit 223 detects the state of the load based on a load signal containing load information and generates a load detecting signal SLOADS indicative of the load state. The load signal can be received from the output terminals of the rear stage circuit 11A or from a PD controller. In other embodiments, the load detecting circuit 223 can also comprehensively consider the signal from the output terminals of the rear stage circuit 11A and the signal from the PD controller to detect the load state.

In the example shown in FIG. 6, the rear stage control circuit 22A includes a secondary power supply pin VDD coupled to the output voltage Vout, a rear feedback pin FB1, a compensating pin COMP and an error amplifying circuit 224. The error amplifying circuit 224 has a first input terminal, a second input terminal and an output terminal, where the first input terminal is coupled to the rear feedback pin FB1 to receive a rear feedback signal Vfb1 related to an output signal (e.g., the output voltage Vout) of the rear stage circuit 11A, the second input terminal receives a first reference voltage Vref1 and the output terminal is coupled to the compensating pin COMP. The error amplifying circuit 224 generates a first error amplifying signal Vcomp1 to the compensating pin COMP based on the first reference voltage Vref1 and the rear feedback signal Vfb1. In one embodiment, the switching converter 200A further includes a rear feedback circuit 227 coupled to the output voltage Vout. The rear feedback circuit 227 includes resistors R2 and R3 for generating the rear feedback signal Vfb1. The load detecting circuit 223 is coupled to the secondary power supply pin VDD to receive the voltage Vdd at the secondary power supply pin VDD and also coupled to the compensating pin COMP to receive the first error amplifying signal Vcomp1 and generates the load detecting signal SLOADS based on the voltage Vdd and the first error amplifying signal Vcomp1.

In another embodiment, the rear stage control circuit 22A includes an external control pin TZ. The PD controller (not shown) generates the load signal containing load information and applies the load signal to the external control pin TZ. The load detecting circuit 223 is coupled to the external control pin TZ, detects the state of the load signal at the external control pin TZ and generates the load detecting signal SLOADS.

In the example shown in FIG. 6, the rear stage circuit 11A is shown as a flyback circuit including a primary side and a secondary side, where the front state control circuit 222 is located at the primary side and the load detecting circuit 223 is located at the secondary side. In order to transmit the load state from the secondary side to the primary side, the rear stage control circuit 22A further includes an isolation circuit 225. In one embodiment, the isolation circuit 225 can include optocoupler, transformer, capacitive isolation device or other suitable electrical isolation devices.

FIG. 7 illustrates a circuit schematic of a rear stage control circuit 22B used in the switching converter 200A in accordance with another embodiment of the present invention. As shown in FIG. 7, the rear stage control circuit 22B includes a line voltage detecting circuit 221B, a front state control circuit 222B, a load detecting circuit 223B, an error amplifying circuit 224B and an isolation circuit 225B.

The error amplifying circuit 224B includes an error amplifier EA1. The error amplifier EA1 has a non-inverting input terminal, an inverting input terminal and an output terminal. The non-inverting input terminal receives the first reference voltage Vref1 and the inverting input terminal is coupled to the rear feedback pin FB1 to receive the rear feedback signal Vfb1. Based on the first reference voltage Vref1 and the rear feedback signal Vfb1, the error amplifier EA1 generates the first error amplifying signal Vcomp1 to the compensating pin COMP.

The load detecting circuit 222B includes a first load comparing circuit 2231, a second load comparing circuit 2232, a third load comparing circuit 2233, a first AND gate AND1 and a second AND gate AND2.

The first load comparing circuit 2231 compares the voltage Vdd at the secondary power supply pin VDD with a first load voltage threshold Vlth1 to generate a first load comparing signal LA1. When the voltage Vdd is higher than the first load voltage threshold Vlth1, the first load comparing signal LA1 is valid (e.g., high level).

The second load comparing circuit 2232 compares the first error amplifying signal Vcomp1 with a second load voltage threshold Vlth2 to generate a second load comparing signal LA2. When the first error amplifying signal Vcomp1 is higher than the second load voltage threshold Vlth2, the second load comparing signal LA2 is valid (e.g., high level).

The third load comparing circuit 2233 compares the first error amplifying signal Vcomp1 with a third load voltage threshold Vlth3 to generate a third load comparing signal LA3, where the third load voltage threshold Vlth3 is higher than the second load voltage threshold Vlth2. When the first error amplifying signal Vcomp1 is higher than the third load voltage threshold Vlth3, the third load comparing signal LA3 is valid (e.g., high level).

The first AND gate AND1 performs a logical AND operation on the first load comparing signal LA1 and the second load comparing signal LA2 to generate a first load detecting signal SLOAD1. The second AND gate AND2 performs a logical AND operation on the first load comparing signal LA1 and the third load comparing signal LA3 to generate a second load detecting signal SLOAD2. When the first load detecting signal SLOAD1 is invalid (e.g., low level), it indicates that the load is in the light load state; when the first load detecting signal SLOAD1 is valid (e.g., high level) and the second load detecting signal SLOAD2 is invalid (e.g., low level), it indicates that the load is in the heavy load state; when the second load detecting signal SLOAD2 is valid (e.g., high level), it indicates that the load is in the peak power state.

The isolation circuit 225B includes an encoding circuit 2251, an isolation unit 2252 and a decoding circuit 2253. The encoding circuit 2251 encodes the first load detecting signal SLOAD1 and the second load detecting signal SLOAD2 indicative of the load state into a signal suitable for transmission in the isolation unit 2252. The isolation unit 2252 transmits the signal to the decoding circuit 2253. The decoding circuit 2253 decodes the signal to obtain a peak power enable signal SPP and a front enable signal SPFC, which work together to indicate the load state. When the front enable signal SPFC is invalid (e.g., low level), it indicates that the load is in the light load state; when the front enable signal SPFC is valid (e.g., high level) and the peak power enable signal SPP is invalid (e.g., low level), it indicates that the load is in the heavy load state; when the peak power enable signal SPP is valid (e.g., high level), it indicates that the load is in the peak power state.

The line voltage detecting circuit 221B includes a hysteresis comparing circuit. The hysteresis comparing circuit compares the input sampling signal Vsamp with a high voltage threshold Vthh and a low voltage threshold Vthl respectively to generate the line voltage detecting signal HL. When the input sampling signal Vsamp is higher than the high voltage threshold Vthh, the line voltage detecting signal HL is valid (e.g., high level), indicating that the input line voltage Vin is in the high line state; when the input sampling signal Vsamp is lower than the low voltage threshold Vthl, the line voltage detecting signal HL is invalid (e.g., low level), indicating that the input line voltage Vin is in the low line state.

The front state control circuit 222B changes the voltage VFC at the front control pin CPFC based on the front enable signal SPFC, the peak power enable signal SPP and line voltage detecting signal HL.

In the example shown in FIG. 7, the front state control circuit 222B includes a first control unit 2221, a pull up circuit 2222 and a pull down circuit 2223.

The first control unit 2221 includes a NOR gate NOR1, a third AND gate AND3, a first NOT gate NT1 and a second NOT gate NT2. The NOR gate NOR1 has a first input terminal, a second input terminal and an output terminal, where the first input terminal receives the peak power enable signal SPP and the second input terminal receives the line voltage detecting signal HL. The third AND gate AND3 has a first input terminal, a second input terminal and an output terminal, where the first input terminal is coupled to the output terminal of the NOR gate NOR1, the second input terminal receives the front enable signal SPFC and the output terminal provides a first control signal CT1. The first NOT gate NT1 has an input terminal and an output terminal, where the input terminal is coupled to the output terminal of the third AND gate AND3 and the output terminal provides a second control signal CT2. The second NOT gate NT2 has an input terminal and an output terminal, where the input terminal receives the front enable signal SPFC and the output terminal provides a third control signal CT3.

The pull up circuit 2222 and the pull down circuit 2223 change the voltage VFC at the front control pin CPFC under the control of the first control signal CT1, the second control signal CT2 and the third control signal CT3. In the example shown in FIG. 7, the pull up circuit 2222 includes a current source 11 and a switch S1 coupled in series between a supply voltage V_{CPFC} and the front control pin CPFC. The pull down circuit 2223 includes a current source 12 and a switch S2 coupled in series between the front control pin CPFC and the reference ground PGND.

When the load is in the peak power state or when the load is in the heavy load state and the input line voltage Vin is in the high line state, the second control signal CT2 is valid (e.g., high level), the switch S2 is turned on and keeps on for the second duration threshold T2, thereby pulling down the voltage VFC to the second voltage V2 and maintaining the second voltage V2 for the second duration threshold T2. Then the switch S2 is turned off to disconnect the pull down circuit 2223 from the front control pin CPFC. Because the front control pin CPFC of the rear stage control circuit 22B and the front feedback pin FB of the front stage control circuit 13 are coupled together (as shown in FIG. 1), the voltage Vfb at the front feedback pin FB is equal to the second voltage V2 when the voltage VFC is pulled down to the second voltage V2 and the voltage VFC is determined by the voltage Vfb when the front control pin CPFC is disconnected from the pull down circuit 2223.

When the load is in the heavy load state and the input line voltage Vin is in the low line state, the first control signal CT1 is valid (e.g., high level), the switch S1 is turned on and keeps on for the first duration threshold T1, thereby pulling up the voltage VFC to the first voltage V1 and maintaining the first voltage V1 for the first duration threshold T1. Then the switch S1 is turned off to disconnect the pull up circuit 2222 from the front control pin CPFC. Because the front control pin CPFC of the rear stage control circuit 22B and the front feedback pin FB of the front stage control circuit 13 are coupled together (as shown in FIG. 1), the voltage Vfb at the front feedback pin FB is equal to the first voltage V1 when the voltage VFC is pulled up to the first voltage V1 and the voltage VFC is determined by the voltage Vfb when the front control pin CPFC is disconnected from the pull up circuit 2222.

When the load is in the light load state, the third control signal CT3 is valid (e.g., high level), the switch S2 is turned on and keeps on for a duration exceeding the third duration threshold T3, thereby pulling down the voltage VFC to the second voltage V2 and maintaining the second voltage V2 for the duration exceeding the third duration threshold T3.

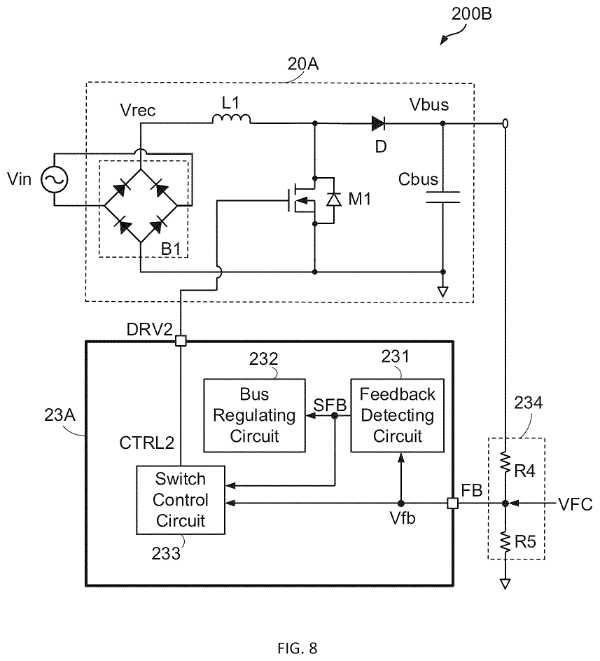

FIG. 8 illustrates a circuit schematic of a switching converter 200B in accordance with another embodiment of the present invention. As shown in FIG. 8, the switching converter 200B includes a front stage circuit 20A and a front stage control circuit 23A. The front stage circuit 20A includes a boost PFC and converts the input line voltage Vin into the bus voltage Vbus.

The front stage control circuit 23A includes a feedback detecting circuit 231, a bus regulating circuit 232, a switch control circuit 233, a front feedback pin FB and a front driving pin DRV2. In one embodiment, the front stage control circuit 23A is integrated into a single chip.

The front feedback pin FB is coupled to the front control pin CPFC of the rear stage control circuit 12 (as shown in FIG. 1) to receive the voltage VFC at the front control pin CPFC.

The feedback detecting circuit 231 is coupled to the front feedback pin FB and detects the voltage Vfb at the front feedback pin FB to generate a feedback state signal SFB indicative of the state of the voltage Vfb.

The bus regulating circuit 232 is coupled to the feedback detecting circuit 231 to receive the feedback state signal SFB and regulates the bus voltage Vbus to the first bus voltage Vbus1 or the second bus voltage Vbus2 based on the state of the voltage Vfb.

The switch control circuit 233 is coupled to the feedback detecting circuit 231 to receive the feedback state signal SFB and is also coupled to the front feedback pin FB. Based on the feedback state signal SFB and the voltage Vfb at the front feedback pin FB, the switch control circuit 233 generates the front switch control signal CTRL2 to control the power operation of the front stage circuit 20A.

In the example shown in FIG. 8, the switching converter 200B further includes a voltage dividing circuit 234 coupled to the bus voltage Vbus. An output terminal of the voltage dividing circuit 234 is coupled to the front feedback pin FB. In one embodiment, the voltage dividing circuit 234 includes resistors R4 and R5.

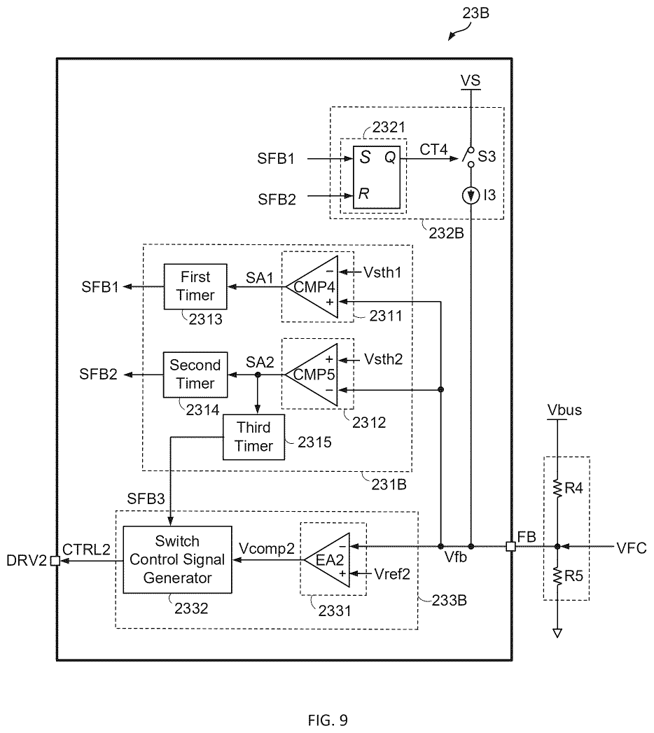

FIG. 9 illustrates a circuit schematic of a front stage control circuit 23B used in the switching converter 200B in accordance with another embodiment of the present invention. As shown in FIG. 9, the front stage control circuit 23B includes a feedback detecting circuit 231B, a bus regulating circuit 232B and a switch control circuit 233B.

In the example shown in FIG. 9, the feedback detecting circuit 231B includes a first state comparing circuit 2311, a second state comparing circuit 2312, a first timer 2313, a second timer 2314 and a third timer 2315.

The first state comparing circuit 2311 compares the voltage Vfb at the front feedback pin FB with a first state voltage threshold Vsth1 and generates a first state comparing signal SA1. When the voltage Vfb is higher than the first state voltage threshold Vsth1, the first state comparing signal SA1 is valid (e.g., high level). The first timer 2313 counts a valid duration of the first state comparing signal SA1 and generates a first feedback state signal SFB1. When the valid duration reaches the first duration threshold T1, the first feedback state signal SFB1 is valid (e.g., high level), indicating that the voltage Vfb has the first state. In one embodiment, the first state comparing circuit 2311 includes a hysteresis comparator.

The second state comparing circuit 2312 compares the voltage Vfb with a second state voltage threshold Vsth2 and generates a second state comparing signal SA2. When the voltage Vfb is lower than the second state voltage threshold Vsth2, the second state comparing signal SA2 is valid (e.g., high level). The second timer 2314 counts a valid duration of the second state comparing signal SA2 and generates a second feedback state signal SFB2. When the valid duration reaches the second duration threshold T2, the second feedback state signal SFB2 is valid (e.g., high level), indicating that the voltage Vfb has the second state. In one embodiment, the second state comparing circuit 2312 includes a hysteresis comparator.

The third timer 2315 counts the valid duration of the second state comparing signal SA2 and generates a third feedback state signal SFB3. When the duration reaches the third duration threshold T3, the third feedback state signal SFB3 is valid (e.g., high level), indicating that the voltage Vfb has the third state.

The bus regulating circuit 232B regulates the bus voltage Vbus based on the first feedback state signal SFB1 and the second feedback state signal SFB2. In the example shown in FIG. 9, the bus regulating circuit 232B includes a second control unit 2321, a switch S3 and a current source 13. The switch S3 and the current source 13 are coupled in series between a supply voltage VS and the front feedback pin FB. The second control unit 2321 includes a RS flip-flop. The RS flip-flop generates a fourth control signal CT4 to control the switch S3 based on the first feedback state signal SFB1 and the second feedback state signal SFB2. When the first feedback state signal SFB1 is valid, indicating that the voltage Vfb has the first state, the fourth control signal CT4 is valid (e.g., high level), the switch S3 is turned on and the current source 13 provides a current flowing into the front feedback pin FB. When the second feedback state signal SFB2 is valid, indicating that the voltage Vfb has the second state, the fourth control signal CT4 is invalid (e.g., low level), the switch S3 is turned off and the current stops flowing into the front feedback pin FB. In another embodiment, the bus regulating circuit 232B also receives the third feedback state signal SFB3. When the third feedback state signal SFB3 is valid, indicating that the voltage Vfb has the third state, the switch S3 is turned off and the current stops flowing into the front feedback pin FB.

The switch control circuit 233B includes an error amplifying circuit 2331 and a switch control signal generator 2332. The error amplifying circuit 2331 generates a second error amplifying signal Vcomp2 based on a second reference voltage Vref2 and the voltage Vfb at the front feedback pin FB. The switch control signal generator 2332 generates the front switch control signal CTRL2 based on the second error amplifying signal Vcomp2 and the third feedback state signal SFB3.

In the example shown in FIG. 9, the voltage Vfb is regulated to be equal to the second reference voltage Vref2 by the control loop and thus the current flowing through the resistor R5 is constant. The current flowing through the resistor R5 is equal to the sum of the current provided by the current source 13 and the current flowing through the resistor R4. When the first feedback state signal SFB1 is valid, indicating that the voltage Vfb has the first state, the current provide by the current source 13 flows into the front feedback pin FB and the current flowing through the resistor R4 decreases, thereby decreasing the bus voltage Vbus to the first bus voltage Vbus1. When the second feedback state signal SFB2 is valid, indicating that the voltage Vfb has the second state, the current provide by the current source 13 stops flowing into the front feedback pin FB and the current flowing through the resistor R4 increases, thereby increasing the bus voltage Vbus to the second bus voltage Vbus2. When the third feedback state signal SFB3 is valid, indicating that the voltage Vfb has the third state, the front switch control signal CTRL2 keeps low level and the front stage circuit 20A stops power operation. At this time, the bus voltage Vbus is equal to the rectified voltage Vrec.

Those skilled in the art can understand that the bus regulating circuit 232B in the example shown in FIG. 9 is used for illustrative purposes, not used for limiting the present invention, other suitable circuits can also applicable here. In one embodiment, the bus regulating circuit 232B can also change the value of the second reference voltage Vref2 based on the first feedback state signal SFB1 and the second feedback state signal SFB2, thereby regulating the bus voltage Vbus to the first bus voltage Vbus1 or the second bus voltage Vbus2.

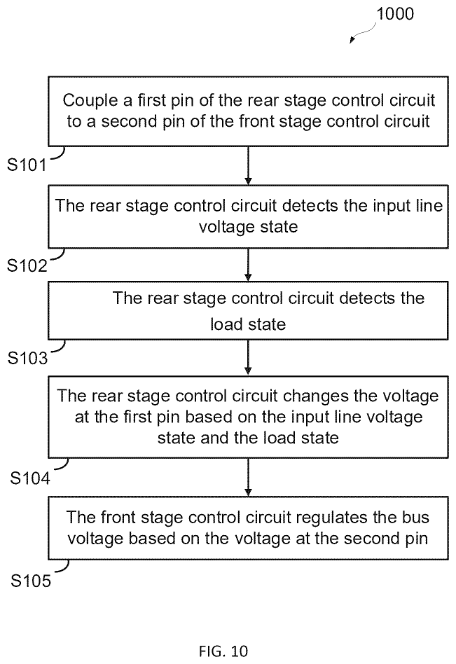

FIG. 10 illustrates a working flowchart of a control method 1000 used in a switching converter in accordance with an embodiment of the present invention. The switching converter includes a front stage circuit converting an input line voltage into a bus voltage, a rear stage circuit converting the bus voltage into an output voltage to power a load, a rear stage control circuit for controlling the power operation of the rear stage circuit and a front stage control circuit for controlling the power operation of the front stage circuit. The control method 1000 includes steps S101˜S105, where steps S102˜104 are performed by the rear stage control circuit and step S105 is performed by the front stage control circuit.

At step S101, a first pin of the rear stage control circuit is coupled to a second pin of the front stage control circuit.

At step 102, the state of the input line voltage is detected.

At step 103, the state of the load is detected.

At step 104, a voltage at the first pin of the rear stage control circuit is changed based on the detected input line voltage state and the detected load state. In one embodiment, when the load is in a heavy load state and the input line voltage is in a low line state, the voltage at the first pin has a first state; when the load is in the heavy load state and the input line voltage is in a high line state or when the load is in a peak power state, the voltage at the first pin has a second state; when the load is in a light load state, the voltage at the first pin has a third state.

At step S105, the bus voltage is regulated based on the voltage at the second pin of the front stage control circuit. In one embodiment, when the voltage at the second pin has a first state, the bus voltage is regulated to a first bus voltage; when the voltage at the second pin has a second state, the bus voltage is regulated to a second bus voltage, where the first bus voltage is lower than the second bus voltage; when the voltage at the second pin has a third state, the front stage circuit is controlled to stop power operation.

Those skilled in the art can understand that the high level/low level of control signal is related to the type of the power switch. For example, if the power switch is N-type MOSFET, when the control signal is high level, the power switch is turned on; when the control signal is low level, the power switch is turned off. If the power switch is P-type MOSFET, when the control signal is high level, the power switch is turned off; when the control signal is low level, the power switch is turned on. The high level/low level of the control signals shown in the above embodiments are used for illustrative purposes, not used for limiting the present invention.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Obviously, many modifications and variations of the present invention are possible in light of the above teachings. It is therefore to be understood that within the scope of the appended claims the invention may be practiced otherwise than as specifically described. It should be understood, of course, the foregoing disclosure relates only to a preferred embodiment (or embodiments) of the invention and that numerous modifications may be made therein without departing from the spirit and the scope of the invention as set forth in the appended claims. Various modifications are contemplated and they obviously will be resorted to by those skilled in the art without departing from the spirit and the scope of the invention as hereinafter defined by the appended claims as only a preferred embodiment(s) thereof has been disclosed.

What is claimed is:

1. A control circuit for a switching converter with a front stage circuit converting an input line voltage into a bus voltage and a rear stage circuit converting the bus voltage into an output voltage to power a load, the control circuit comprising:
a rear stage control circuit configured to provide a rear switch control signal to control the power operation of the rear stage circuit, wherein the rear stage control circuit comprises a first pin and is configured to change a voltage at the first pin based on an input line voltage state and a load state; and
a front stage control circuit configured to provide a front switch control signal to control the power operation of the front stage circuit, wherein the front stage control circuit comprises a second pin coupled to the first pin of the rear stage control circuit and is configured to regulate the bus voltage based on a voltage at the second pin.

2. The control circuit of claim 1, wherein:
when the load is in a heavy load state and the input line voltage is in a low line state, the voltage at the second pin has a first state;
when the load is in the heavy load state and the input line voltage is in a high line state, the voltage at the second pin has a second state; and
when the load is in a light load state, the voltage at the second pin has a third state.

3. The control circuit of claim 2, wherein:
when the load is in a peak power state, the voltage at the second pin has the second state.

4. The control circuit of claim 2, wherein:
when the voltage at the second pin has the first state, the front stage control circuit is configured to regulate the bus voltage to a first bus voltage;
when the voltage at the second pin has the second state, the front stage control circuit is configured to regulate the bus voltage to a second bus voltage, wherein the second bus voltage is higher than the first bus voltage; and
when the voltage at the second pin has the third state, the front stage circuit is configured to stop power operation.

5. The control circuit of claim 2, wherein:
the voltage at the second pin having the first state comprises the voltage at the second pin being pulled up to a first voltage and maintaining the first voltage for a first duration threshold;
the voltage at the second pin having the second state comprises the voltage at the second pin being pulled down to a second voltage and maintaining the second voltage for a second duration threshold; and
the voltage at the second pin having the third state comprises the voltage at the second pin being pulled down to the second voltage and maintaining the second voltage for a duration exceeding a third duration threshold, wherein the third duration threshold is longer than the second duration threshold.

6. The control circuit of claim 1, wherein the front stage circuit comprises a power factor correction circuit and the rear stage circuit comprises a flyback circuit.

7. A control circuit for a switching converter converting an input line voltage into a bus voltage, the control circuit comprising:
a first pin configured to receive information about a state of the input line voltage state and a state of a load;
a second pin configured to provide a switch control signal to control the power operation of the switching converter; and
a switch control circuit coupled to the first pin and configured to generate the switch control signal based on a voltage at the first pin; wherein
the control circuit is configured to regulate the bus voltage to different values based on different states of the voltage at the first pin.

8. The control circuit of claim 7, wherein:
when the voltage at the first pin has a first state, the control circuit is configured to regulate the bus voltage to a first bus voltage;
when the voltage at the first pin has a second state, the control circuit is configured to regulate the bus voltage to a second bus voltage, wherein the second bus voltage is higher than the first bus voltage; and
when the voltage at the first pin has a third state, the switching converter is configured to stop power operation.

9. The control circuit of claim 8, wherein:
when the load is in a heavy load state and the input line voltage is in a low line state, the voltage at the first pin has the first state;
when the load is in the heavy load state and the input line voltage is in a high line state, the voltage at the first pin has the second state; and
when the load is in a light load state, the voltage at the first pin has the third state.

10. The control circuit of claim 9, wherein:
when the load is in a peak power state, the voltage at the first pin has the second state.

11. The control circuit of claim 8, further comprising:
a first state comparing circuit configured to compare the voltage at the first pin with a first state voltage threshold to generate a first state comparing signal;
a first timer configured to count a valid duration of the first state comparing signal to generate a first feedback state signal, wherein when the valid duration reaches a first duration threshold, the first feedback state signal is valid indicating that the voltage at the first pin has the first state;
a second state comparing circuit configured to compare the voltage at the first pin with a second state voltage threshold to generate a second state comparing signal;
a second timer configured to count a valid duration of the second state comparing signal to generate a second feedback state signal, wherein when the valid duration reaches a second duration threshold, the second feedback state signal is valid indicating that the voltage at the first pin has the second state; and
a third timer configured to count the valid duration of the second state comparing signal to generate a third feedback state signal, wherein when the valid duration reaches a third duration threshold, the third feedback state signal is valid indicating that the voltage at the first pin has the third state, wherein the third duration threshold is longer than the second duration threshold.

12. The control circuit of claim 8, further comprising:
a switch; and
a current source, wherein the switch and the current source are coupled in series between a supply voltage and the first pin; wherein
in response to the voltage at the first pin having the first state, the switch is configured to be turned on and the current source is configured to provide a current flowing into the first pin; and wherein
in response to the voltage at the first pin having the second state, the switch is configured to be turned off and the current is configured to stop flowing into the first pin.

13. The control circuit of claim 7, wherein the switching converter is configured to provide the bus voltage to a rear stage circuit converting the bus voltage into an output voltage to power the load, wherein:
the first pin is configured to be coupled to a pin of a control circuit for the rear stage circuit, to receive the information about the input line voltage state and the load state.

14. A control circuit for a switching converter converting a bus voltage into an output voltage, the control circuit comprising:
a first pin configured to receive a load signal indicative of a load;
a second pin configured to receive an input sampling signal indicative of an input line voltage;
a third pin;
a fourth pin configured to provide a switch control signal to control the power operation of the switching converter;
a load detecting circuit configured to detect a state of the load based on the load signal;
a line voltage detecting circuit configured to detect a state of the input line voltage based on the input sampling signal; and
a front state control circuit configured to change a voltage at the third pin based on the load state and the input line voltage state.

15. The control circuit of claim 14, wherein:
when the load is in a heavy load state and the input line voltage is in a low line state, the voltage at the third pin has a first state;
when the load is in the heavy load state and the input line voltage is in a high line state, the voltage at the third pin has a second state; and
when the load is in a light load state, the voltage at the third pin has a third state.

16. The control circuit of claim 15, wherein:
when the load is in a peak power state, the voltage at the third pin has the second state.

17. The control circuit of claim 15, wherein:
the voltage at the third pin having the first state comprises the voltage at the third pin being pulled up to a first voltage and maintaining the first voltage for a first duration threshold;
the voltage at the third pin having the second state comprises the voltage at the third pin being pulled down to a second voltage and maintaining the second voltage for a second duration threshold; and
the voltage at the third pin having the third state comprises the voltage at the third pin being pulled down to the second voltage and maintaining the second voltage for a duration exceeding a third duration threshold, wherein the third duration threshold is longer than the second duration threshold.

18. The control circuit of claim 15, wherein the front state control circuit comprises:
a first switch and a first current source coupled in series between a supply voltage and the third pin; and
a second switch and a second current source coupled in series between the third pin and a reference ground; wherein
when the load is in the heavy load state and the input line voltage is in the low line state, the first switch is configured to be turned on for a first duration threshold;
when the load is in the heavy load state and the input line voltage is in the high line state, the second switch is configured to be turned on for a second duration threshold; and
when the load is in the light load state, the second switch is configured to be turned on for a duration exceeding a third duration threshold, wherein the third duration threshold is longer than the second duration threshold.

19. The control circuit of claim 14, further comprising:
a fifth pin configured to receive an error amplifying signal between a reference voltage and a feedback signal indicative of the output voltage; and
a sixth pin configured to be coupled to the output voltage;
wherein the load detecting circuit comprises:
a first load comparing circuit configured to compare a voltage at the sixth pin with a first load voltage threshold to generate a first load comparing signal;
a second load comparing circuit configured to compare a voltage at the fifth pin with a second load voltage threshold to generate a second load comparing signal;
a third load comparing circuit configured to compare the voltage at the fifth pin with a third load voltage threshold to generate a third load comparing signal, wherein the third load voltage threshold is higher than the second load voltage threshold;
a first AND gate configured to perform a logical AND operation on the first load comparing signal and the second load comparing signal to generate a first load detecting signal; and
a second AND gate configured to perform a logical AND operation on the first load comparing signal and the third load comparing signal to generate a second load detecting signal.

20. The control circuit of claim 14, wherein the switching converter is configured to be coupled to a front stage circuit converting the input line voltage into the bus voltage, wherein:
the third pin is configured to be coupled to a pin of a control circuit for the front stage circuit, to transmit the voltage change at the third pin to the control circuit for the front stage circuit.
